(19) United States
(12) Patent Application Publication
(10) Pub. No.: US 2008/0018588 A1
(43) Pub. Date: Jan. 24, 2008

(54) LIQUID CRYSTAL DISPLAY DEVICE

(75) Inventors: Toshiaki Yoshihara, Kawasaki (JP); Tetsuya Makino, Kakogawa (JP); Shinji Tadaki, Kawasaki (JP); Hironori Shiroto, Kobe (JP); Yoshinori Kiyota, Kawasaki (JP); Keiichi Betsui, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited.

(21) Appl. No.: 11/864,773

(22) Filed: Sep. 28, 2007

Related U.S. Application Data
(63) Continuation of application No. PCT/JP2005/005943, filed on Mar. 29, 2005.

(51) Int. Cl. G09G 3/36

(52) U.S. Cl. 345/102

(57) ABSTRACT

In a predetermined period (one frame or one subframe), a backlight is lit between the mid-point of primary data-writing scanning and the mid-point of secondary data-writing scanning for each of lighting regions of which the backlight is divided into four. When the time required for the data-writing scanning is 50% of the predetermined time, the ratio of the time the liquid crystal panel is in the transmission state to the time the backlight is lit (panel-on rate) is high at 93.8%. The ratio of the brightness gradient (luminance at the center of the display area/luminance at the edge of the display area) is low at 1.14 to one. If the backlight is divided into 10 and lit, the panel-on rate can be increased to 97.5%, and the ratio of the brightness gradient can be reduced to 1.05 to one.

### TECHNICAL FIELD

The present invention relates to a liquid crystal display device, and more particularly to, a liquid crystal display device that synchronizes data writing scanning to a liquid crystal panel and lighting control of a light source for display.

### BACKGROUND ART

Along with the development of the so-called information society in recent years, electronic equipment represented by a personal computer, a PDA (Personal Digital Assistant), etc., has been widely used. Along with the spread of such electronic equipment, the demand of portable equipment that can be used in the office and outdoor has emerged, and miniaturization and downsizing of the equipment are desired. The liquid crystal display device is widely used as one of the ways to achieve such an object. The liquid crystal display is an indispensable technology not only for miniaturization and downsizing, but also for the energy saving of the portable electronic equipment powered by batteries.

The liquid crystal display device is roughly classified into reflection-type and transmission-type. The reflection-type has a composition in which the optical beam entered from the front side of the liquid crystal panel is reflected onto the back side of the liquid crystal panel, and the image is visualized by the reflected light. The transmission-type has a composition in which the image is visualized by the transmission light from the light source (backlight) provided on the back of the liquid crystal panel. Since the amount of the reflected light of the reflection-type is not consistent depending on environmental conditions and low in visibility, the transmissive color liquid crystal display with color filters is generally used as a display especially for the displays of personal computers, etc., that display multicolor or full color images.

An active drive display device that uses a switching device such as a TFT (Thin Film Transistor) is currently in wide use as for the color liquid crystal display device. Although the display quality of the TFT-driven liquid crystal display device is high, since only several percent of light transmissivity of the liquid crystal panel exists under current circumstances, a high-luminance backlight is needed to obtain high screen luminance. Therefore, the power consumption by the backlight will be large. Moreover, since color filters are used for the color display, one pixel must be composed of three sub-pixels, so that achieving higher resolution is difficult and the display color purity is also unsatisfactory.

In order to solve such a problem, the inventors of the present invention have developed a field-sequential liquid crystal display device (see, e.g., non-patent documents 1, 2, and 3). Since the field-sequential liquid crystal display device doesn't require sub-pixels, as opposed to the color-filter liquid crystal display device, the display with higher resolution can be easily achieved, and since the emission color of the light source can be used as it is for the display without using color filters, the display color purity is also excellent. In addition, since the light use efficiency is also high, the field-sequential liquid crystal display device has an advantage that less power consumption is needed. However, the rapid response of the liquid crystal (2 ms or less) is indispensable to realize the field-sequential liquid crystal display device.

In order to achieve the high-speed response of the field-sequential liquid crystal display device or the color-filter liquid crystal display device having excellent advantages described above, the inventors of the present invention have researched and developed a drive by a switching element such as a TFT of the liquid crystal of ferroelectric liquid crystals, etc., including spontaneous polarization that is expected to have 100-1000 times higher speed response compared to a conventional device (see, e.g., patent document 1). The major axis direction of the liquid crystal molecules of the ferroelectric liquid crystal tilt by applying the voltage. A liquid crystal panel that sandwiches the ferroelectric liquid crystal is placed between two polarizing plates with orthogonal polarizing axes, and the double refraction by the change in the major axis direction of the liquid crystal molecules is used to change the transmission light intensity.

[Patent Document 1] Japanese Patent Application Laid-Open No. 1999-119189.

[Non-Patent Document 1] T. Yoshihara, et. al., ILCC 98, P1-074, 1998.

[Non-Patent Document 2] T. Yoshihara, et. al., AM-LCD'99 Digest of Technical Papers, P185, 1999.

[Non-Patent Document 3] T. Yoshihara, et. al., SID'00 Digest of Technical Papers, P1176, 2000.

### DISCLOSURE OF THE INVENTION

### Problems to be Solved by the Invention

Although the field-sequential liquid crystal display device has advantages that the light use efficiency is high and the reduction of power consumption is possible, the reduction of further power consumption is requested for installation on the portable equipment. The demand for the reduction of such power consumption applies not only to the field-sequential liquid crystal display device, but also to the color-filter liquid crystal display device.

The present invention has been made in view of such circumstances, and an object of the present invention is to provide a liquid crystal display device capable of improving the efficiency of the light from the light source for display and achieving the reduction of power consumption.

A further object of the present invention is to provide a liquid crystal display device capable of controlling the brightness gradient and lengthening the scanning time.

### Means for Solving the Problems

A first aspect of the liquid crystal display device performs a synchronization of lighting control of a light source that emits a light entering into a liquid crystal panel that encloses a liquid crystal material and of multiple data-writing scanning to the liquid crystal panel, for each predetermined period, characterized in that the light source is divided into a plurality of lighting regions and lit, and that the light source is lit between corresponding timings of the first scanning of one or more primary data-writing scanning within the predetermined period corresponding to each of the lighting regions and the first scanning of one or more secondary data-writing scanning for obtaining darker display or display of substantially the same brightness as that of the primary data-writing scanning.

According to the first aspect of the liquid crystal display device, corresponding to each of the plurality of divided lighting regions of the light source (backlight) for display, the light source (backlight) is lit between a certain timing of the first scanning of the primary data-writing scanning in a predetermined period (one frame or one subframe) and a timing of the first scanning of the secondary data-writing scanning in a predetermined time (one frame or one subframe) corresponding to the above timing. Therefore, the light use efficiency improves as described below, and the reduction of power consumption of the light source (backlight) can be achieved. In addition, the brightness gradient can be controlled, and the scanning time can be lengthened.

FIG. 1 is a view of one example of a drive sequence according to such a liquid crystal display device of the present invention. FIG. 1(a) illustrates a scanning timing of each line of the liquid crystal panel and FIG. 1(b) illustrates a lighting timing of the backlight. In this example, the lighting regions of the backlight are divided into four in the scanning direction, and in each of the lighting regions that are divided into four, the backlight is lit between the mid-point of the primary data-writing scanning and the mid-point of the secondary data-writing scanning in a predetermined period (one frame or one subframe). To clarify the relationship between the timing of the data-writing scanning and the timing of lighting at each lighting region, the data-writing scanning is illustrated with broken lines in FIG. 1(b).

FIG. 2 is a view of one example as a comparative example of a drive sequence according to the liquid crystal display. FIG. 2(a) illustrates a scanning timing of each line of the liquid crystal panel and FIG. 2(b) illustrates a lighting timing of the backlight. In the example of FIG. 2, the backlight is lit between the mid-point of the primary data-writing scanning and the mid-point of the secondary data-writing scanning within a predetermined time (one frame or one subframe). However, the backlight is not divided into a plurality of lighting regions.

As in the comparative example of FIG. 2, when the time required for each data-writing scanning is 50% of the one frame or one subframe, the ratio of the time the liquid crystal panel is in the transmission state to the time the backlight is lit (hereinafter, also referred to as panel-on rate) is low at 75%, and the light use efficiency is low. When the time required for each data-writing scanning is shortened to 25% of the one frame or one subframe, the panel-on rate is increased to 67% which is still not enough.

Since the backlight is lit between the mid-point of the primary data-writing scanning and the mid-point of the secondary data-writing scanning, the luminance is different in the central regions and the end regions of the display area. The ratio of the brightness gradient (luminance at the center of the display area/luminance at the edge of the display area) is two to one when the time of the data-writing scanning is 50% of one frame or one subframe. Even when the time of the data-writing scanning is 25% of one frame or one subframe, the ratio is still high at 1.33 to one.

As described, although favorable results of the light use efficiency and the brightness gradient can be obtained by decreasing the ratio that the time of data-writing scanning accounts for in one frame or one subframe, this imposes a heavy load on the driver IC and the controlling circuit.

On the other hand, according to the first aspect, even when the time required for the data-writing scanning is 50% of one frame or one subframe, as shown in FIG. 1, by dividing the backlight into four and lighting it, the panel-on rate becomes high at 93.8%. The ratio of the brightness gradient at this point is low at 1.14 to one. By further dividing the backlight into 10 and lighting it, the panel-on rate becomes higher at 97.5% and the ratio of the brightness gradient becomes smaller at 1.05 to one.

As described, since significantly high panel-on rate can be realized in the first aspect, the light use efficiency can be improved and the reduction of power consumption can be achieved. The brightness gradient can also be controlled and the scanning time can be lengthened. When the scanning time is further shortened, the light use efficiency can be further improved and the brightness gradient can be further controlled.

A second aspect of the liquid crystal display device is characterized in that the corresponding timings are substantially the mid-points of the respective first scanning.

According to the second aspect of the liquid crystal display device, the timings of the start and end of the lighting of the light source (backlight) in each lighting region are substantially at the mid-points of the data-writing scanning. Therefore, the brightness gradient is substantially symmetrical over and under in the data-writing scanning direction of the liquid crystal panel, and compared to the case where the timings of the start and end of the lighting of the light source (backlight) are not at the mid-points of the data-writing scanning, the brightness gradient is smaller which enables the excellent display.

A third aspect of the liquid crystal display device is characterized in that, in conjunction with each of the plurality of pixels, a switching element that controls a voltage applied to the liquid crystal material is provided.

According to the third aspect of the liquid crystal display device, a switching element that controls the voltage applied to the liquid crystal material is provided on each pixel. Therefore, the voltage of each pixel is easily controlled, and compared to a simple matrix liquid crystal display device that is not provided with the switching element, clear display can be obtained.

A fourth aspect of the liquid crystal display device is characterized in that the liquid crystal material includes spontaneous polarization.

According to the fourth aspect of the liquid crystal display device, a material having spontaneous polarization is used as a liquid crystal material. Since the use of a liquid crystal material having spontaneous polarization enables the high-speed response, enhanced image display characteristics can be realized, and the field sequential display can also be easily realized. Especially, as a liquid crystal material having spontaneous polarization, using a ferroelectric liquid crystal with a low spontaneous polarization value facilitates the drive by the switching element such as a TFT.

A fifth aspect of the liquid crystal display device is characterized in that the voltage applied to the liquid crystal material in the primary data-writing scanning and the voltage applied to the liquid crystal material in the secondary data-writing scanning are equal in magnitude and different in polarity.

According to the fifth aspect of the liquid crystal display device, the magnitude of the voltages applied to the liquid crystal materials are equal and the polarity is different between the primary data-writing scanning and the secondary data-writing scanning in one frame or one subframe. As a result, deviation of the voltage applied to the liquid crystal material is suppressed and image sticking is prevented.

A sixth aspect of the liquid crystal display device is characterized in that the secondary data-writing scanning is conducted after the primary data-writing scanning.

According to the sixth aspect of the liquid crystal display device, in one frame or one subframe, after the primary data-writing scanning for obtaining bright display, the secondary data-writing scanning for obtaining darker display or display of substantially the same brightness as that of the primary data-writing scanning is conducted. In this way, especially in the field-sequential method, the color mixture of the display can be controlled since the dark display is conducted after the bright display in the subframe of each color. On the contrary, when the bright display is conducted after the dark display in the subframe of each color, the color mixture occurs as the scanning heads toward the downstream during the line scanning, and a color different from the desired display color is displayed. This can be prevented in the sixth aspect.

A seventh aspect of the liquid crystal display device is characterized in that the color display is performed by the field-sequential method.

According to the seventh aspect of the liquid crystal display device, the color display is performed by the field-sequential method that sequentially switches the lights of a plurality of colors. Therefore, the color display with high resolution, high color purity, and rapid response can be achieved.

An eighth aspect of the liquid crystal display device is characterized in that the color display is performed by the color-filter method.

According to the eighth aspect of the liquid crystal display device, the color display is performed by the color-filter method using color filters. Therefore, the color display can easily be performed.

A ninth aspect of the liquid crystal display device is characterized in that the light source is a light emitting diode.

According to the ninth aspect of the liquid crystal display device, a light emitting diode is used as a light source for display. Therefore, switching the light on and off can be easily conducted, and the light source is easily divided.

### EFFECTS OF THE INVENTION

According to the present invention, corresponding to each of a plurality of lighting areas of which the light source (backlight) for display is divided, the light source (backlight) is lit between corresponding timings during the first scanning of each of primary data-writing scanning and secondary data-writing scanning in a predetermined period (one frame or one subframe). As a result, light use efficiency of field-sequential and color-filter liquid crystal display devices can be improved, and the liquid crystal display device achieving the reduction of power consumption can be realized. In addition, control of the brightness gradient and scanning time lengthening can also be accomplished.

### BRIEF DESCRIPTION OF THE DRAWINGS

FIG. 1 illustrates one example of a drive sequence of a liquid crystal display device according to the present invention, the solid lines illustrating primary data-writing scanning and the broken lines illustrating secondary data-writing scanning.

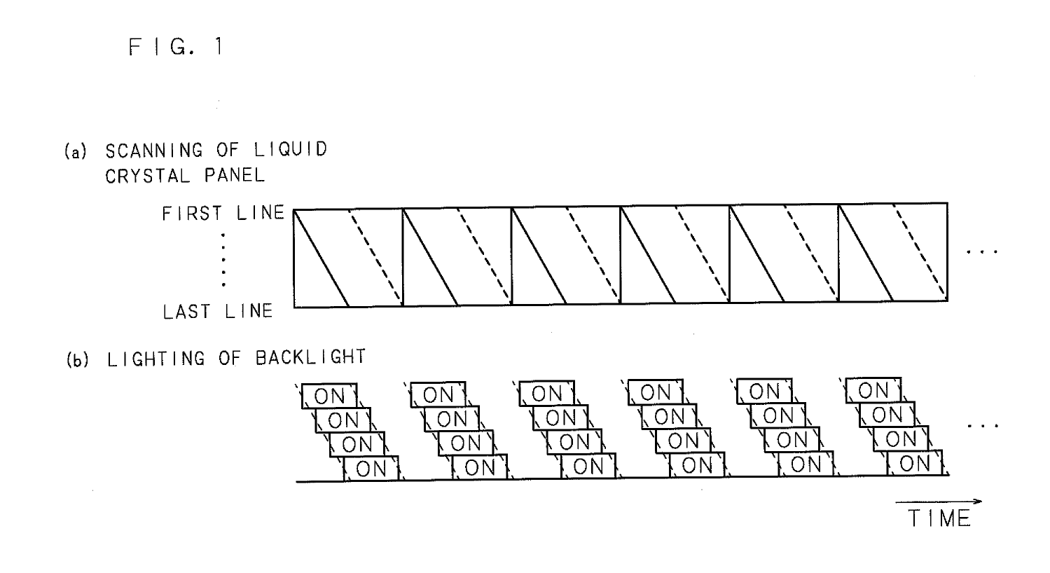

FIG. 2 illustrates one example of a drive sequence of the liquid crystal display device of a comparative example, the solid lines illustrating the primary data-writing scanning and the broken lines illustrating the secondary data-writing scanning.

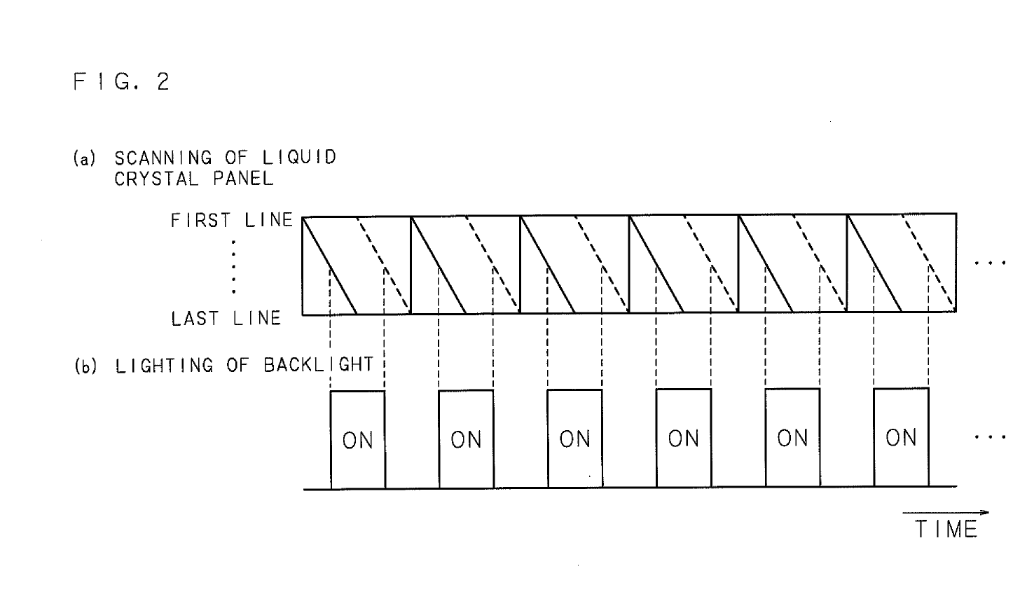

FIG. 3 is a block diagram of a circuit configuration of the liquid crystal display device according to the present invention.

FIG. 4 is a schematic cross-sectional view of a liquid crystal panel and a backlight of a field-sequential liquid crystal display device.

FIG. 5 is a schematic view of a configuration example of the entire liquid crystal display device.

FIG. 6 is a schematic view of a configuration example of a LED array.

FIG. 7 illustrates a drive sequence of the liquid crystal display device of a first embodiment, the solid lines illustrating the primary data-writing scanning and the broken lines illustrating the secondary data-writing scanning.

FIG. 8 illustrates a drive sequence of the liquid crystal display device of a first comparative example, the solid lines illustrating the primary data-writing scanning and the broken lines illustrating the secondary data-writing scanning.

FIG. 9 illustrates a drive sequence of the liquid crystal display device of a second embodiment, the solid lines illustrating the primary data-writing scanning and the broken lines illustrating the secondary data-writing scanning.

FIG. 10 illustrates a drive sequence of the liquid crystal display device of a second comparative example, the solid lines illustrating the primary data-writing scanning and the broken lines illustrating the secondary data-writing scanning.

FIG. 11 illustrates a drive sequence of the liquid crystal display device of a third embodiment, the solid lines illustrating the primary data-writing scanning and the broken lines illustrating the secondary data-writing scanning.

FIG. 12 is a schematic cross-sectional view of a liquid crystal panel and a backlight of the color-filter liquid crystal display device.

FIG. 13 illustrates one example of a drive sequence of the color-filter liquid crystal display device, the solid lines illustrating the primary data-writing scanning and the broken lines illustrating the secondary data-writing scanning.

### DESCRIPTION OF THE NUMERALS

7 LED array
13 liquid crystal layer
21 liquid crystal panel
22 backlight
23 data driver
33 scan driver
35 backlight controlling circuit
41 TFT
70 white light source
221, 222, 223, 224 lighting region

### BEST MODE FOR IMPLEMENTING THE INVENTION

The present invention will now be specifically described with reference to the drawings depicting the embodiments. However, the present invention is not limited to the following embodiments.

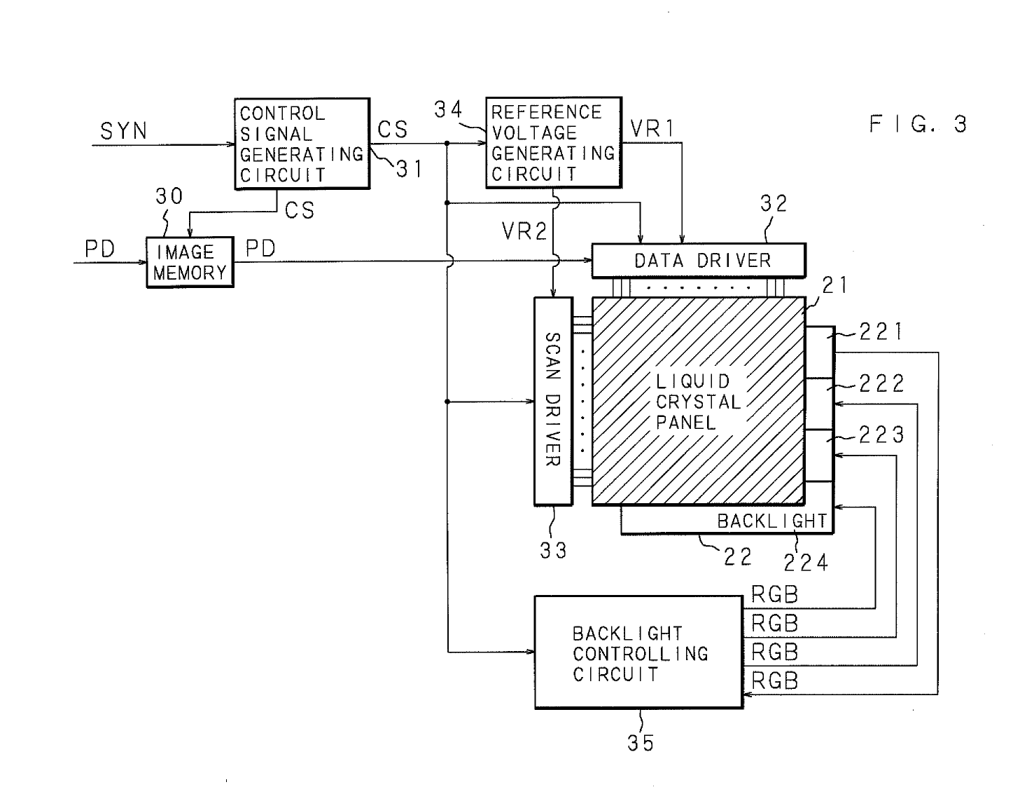

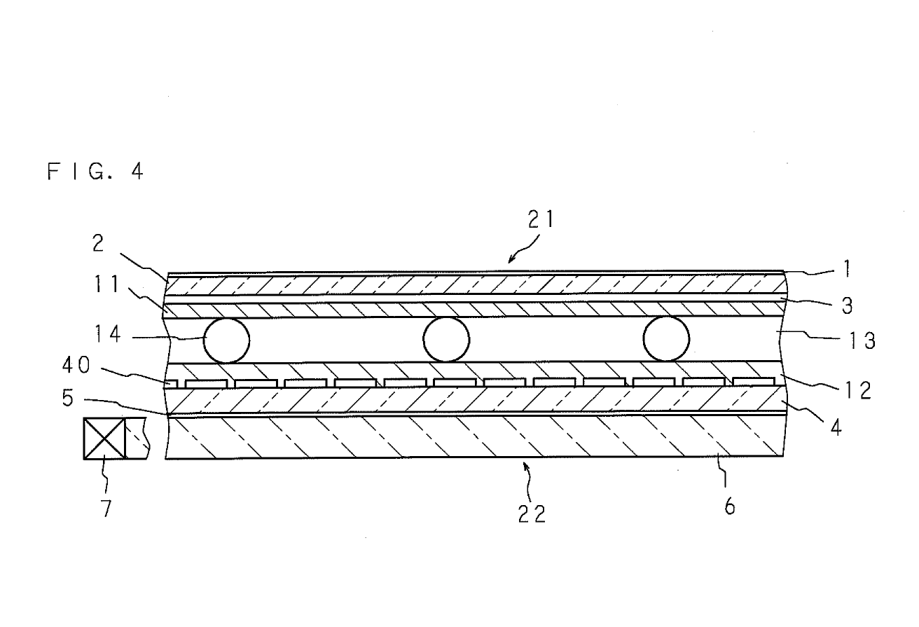

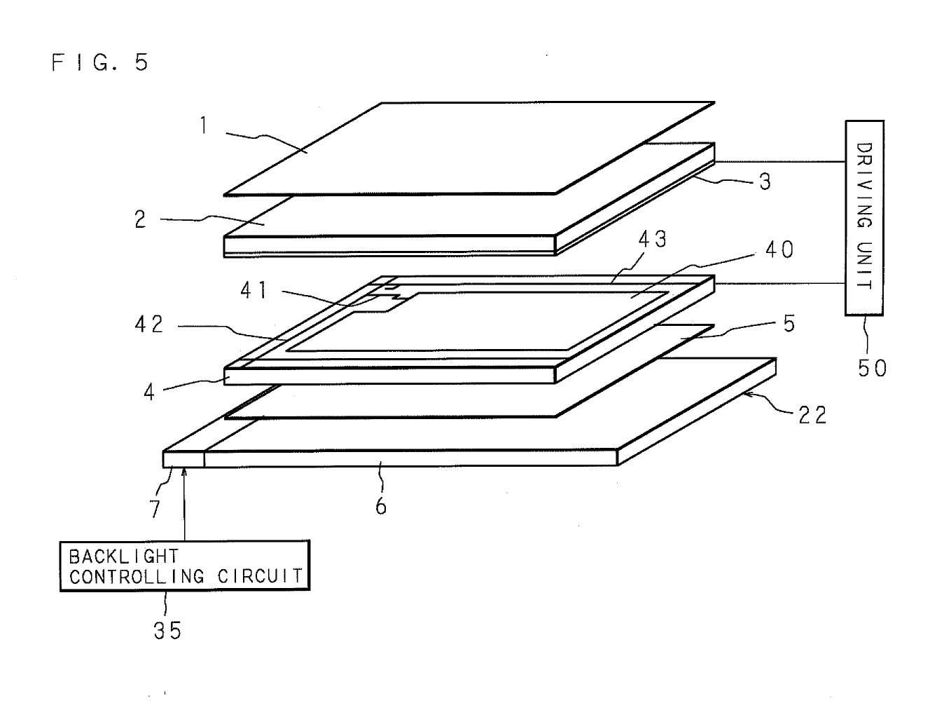

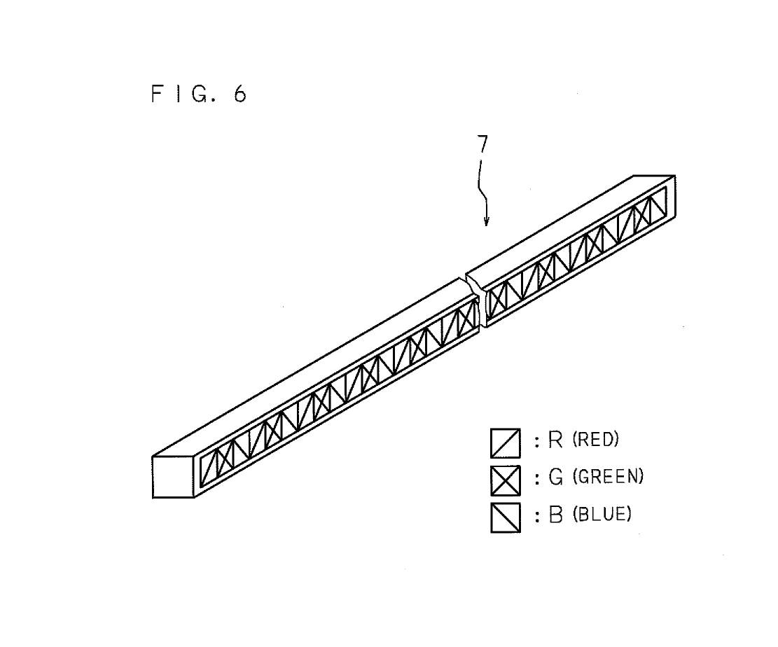

FIG. 3 is a block diagram of a circuit configuration of a liquid crystal display device of the present invention. FIG. 4 is a schematic cross-sectional view of a liquid crystal panel and a backlight. FIG. 5 is a schematic view of a configuration example of the entire liquid crystal display device. FIG. 6 is a schematic view of a configuration example of a LED (Laser Emitting Diode) array that is a light source of the backlight.

In FIGS. 3, 21 and 22 indicate a liquid crystal panel and a backlight whose cross-sectional configurations are illustrated in FIG. 4. As shown in FIG. 4, the backlight 22 includes a LED array 7 and a light guide and light diffusion plate 6. As shown in FIGS. 4 and 5, the liquid crystal panel 21 is configured by laminating a polarization film 1, a glass substrate 2, a common electrode 3, a glass substrate 4, and a polarization film 5 in this order from the upper layer (front face) to the lower layer (back face). On the side of the glass substrate 4 closer to the common electrode 3, pixel electrodes 40, 40 . . . are formed that are arranged in matrix.

Between these common electrode 3 and pixel electrodes 40, 40 . . . a driving unit 50 consisting of a data driver 32, a scan driver 33, etc., is connected. The data driver 32 is connected to a TFT 41 via a signal line 42, and the scan driver 33 is connected to the TFT 41 via a scan line 43. The TFT 41 is on/off controlled by the scan driver 33. Each of the pixel electrodes 40, 40 . . . is connected to the TFT 41. Thus, signals from the data driver 32 provided via the signal line 42 and TFT 41 control the transmission light intensity of each pixel.

An alignment film 12 is arranged on the upper surface of the pixel electrodes 40, 40 . . . on the glass substrate 4, and an alignment film 11 is arranged on the lower surface of the common electrode 3. A liquid crystal material is filled between these alignment films 11 and 12 to form a liquid crystal layer 13. 14 is spacers for maintaining the layer thickness of the liquid crystal layer 13.

The backlight 22 is located closer to the lower layer (back face) of the liquid crystal panel 21, and the LED array 7 is provided facing the end surface of the light guide and light diffusion plate 6 that constitutes an emission region. The LED array 7, as shown in the schematic view of FIG. 6, includes a plurality of LEDs having a LED element as one chip that emits three primary colors of red (R), green (G), and blue (B) to the surface facing the light guide and light diffusion plate 6. In each subframe of red, green, and blue, LED elements of red, green, and blue are lit respectively. The light guide and light diffusion plate 6 function as an emission region by guiding the light from each LED of the LED array 7 onto its entire surface and diffusing the light to the upper surface.

In the present invention, the backlight 22 is divided into four lighting regions 221, 222, 223, and 224 in accordance with the line direction of the liquid crystal panel 21. An emission timing and an emission color of each of these lighting regions 221, 222, 223, and 224 are independently controlled by a backlight controlling circuit 35.

This liquid crystal panel 21 and the backlight 22 capable of time-division emitting of red, green, and blue for each lighting region are overlaid. The lighting timing and emission color in each lighting region of the backlight 22 are controlled in synchronization with data-writing scanning based on display data to the liquid crystal panel 21.

In FIG. 3, 31 is a control signal generating circuit to which a synchronization signal SYN is inputted from a personal computer and that generates various control signals CS necessary for display. From an image memory 30, pixel data PD is outputted to the data driver 32. Based on the pixel data PD and the control signal CS for changing the polarity of applied voltage, a voltage is applied to the liquid crystal panel 21 via the data driver 32.

From the control signal generating circuit 31, the control signals CS are outputted to a reference voltage generating circuit 34, the data driver 32, the scan driver 33, and the backlight controlling circuit 35. The reference voltage generating circuit 34 generates reference voltages VR1 and VR2 and outputs the generated reference voltage VR1 to the data driver 32 and the reference voltage VR2 to the scan driver 33. The data driver 32 outputs a signal to the signal line 42 of the pixel electrode 40 based on the pixel data PD from the image memory 30 and the control signal CS from the control signal generating circuit 31. In synchronization with this signal output, the scan driver 33 sequentially scans each line of the scan lines 43 of the pixel electrode 40. The backlight controlling circuit 35 applies a drive voltage to the backlight 22, causing each of the lighting regions 221, 222, 223, and 224 of the backlight 22 to emit a red light, green light, and blue light.

An operation of the liquid crystal display device will now be described. The pixel data PD for display is inputted from a personal computer to the image memory 30 which temporarily stores the pixel data PD and then outputs the pixel data PD when accepting the control signal CS outputted from the control signal generating circuit 31. The control signals CS generated by the control signal generating circuit 31 are provided to the data driver 32, scan driver 33, reference voltage generating circuit 34, and backlight controlling circuit 35. The reference voltage generating circuit 34 generates the reference voltages VR1 and VR2 when receiving the control signal CS and then outputs the generated reference voltage VR1 to the data driver 32 and the reference voltage VR2 to the scan driver 33.

When receiving the control signal CS, the data driver 32 outputs a signal to the signal line 42 of the pixel electrode 40 based on the pixel data PD outputted from the image memory 30. When receiving the control signal CS, the scan driver 33 sequentially scans each line of the scan lines 43 of the pixel electrode 40. As the signal is outputted from the data driver 32 and scanning is conducted by the scan driver 33, the TFT 41 is driven, a voltage is applied to the pixel electrode 40, and transmission light intensity of the pixels is controlled. When receiving the control signal CS, the backlight controlling circuit 35 applies the drive voltage to the backlight 22, causing the red, green, and blue LED elements included in the LED array 7 of the backlight 22 to time-divide in each of the lighting regions to emit lights, and causing to sequentially emit red lights, green lights, and blue lights. In this way, the color display is performed by synchronizing lighting control of each lighting region of the backlight 22 that emits the incident light to the liquid crystal panel 21 and a plurality of data-writing scanning to the liquid crystal panel 21.

### FIRST EMBODIMENT

After cleaning a TFT substrate having pixel electrodes 40, 40 . . . (640×480 in number of pixels and 3.2 inches in diagonal) and the glass substrate 2 having the common electrode 3, by applying polyimide and firing them for one hour at 200° C., about 200 Å polyimide films are formed as alignment films 11 and 12. In addition, these alignment films 11 and 12 are rubbed with a cloth of rayon, and an empty panel is created by overlaying these two substrates such that the rubbing directions are parallel. In this case, between the substrates of the empty panel, the gap is retained with the spacers 14 made of silica having 1.6 μm of mean diameter. Between the alignment films 11 and 12 of the empty panel, a ferroelectric liquid crystal material (for example, a material disclosed in A. Mochizuki, et. al.: Ferroelectrics, 133, 353 (1991)) having naphthalene liquid crystal as a principal ingredient exhibiting half-V-shaped electro-optical response characteristics is enclosed to form the liquid crystal layer 13. The magnitude of the spontaneous polarization of the enclosed ferroelectric liquid crystal material is 6 nC/cm². The manufactured panel is interposed between two polarization films 1 and 5 in the crossed Nicol arrangement to produce the liquid crystal panel 21, and when the major axis direction of the ferroelectric liquid crystal molecules tilts to one side, it becomes a dark state.

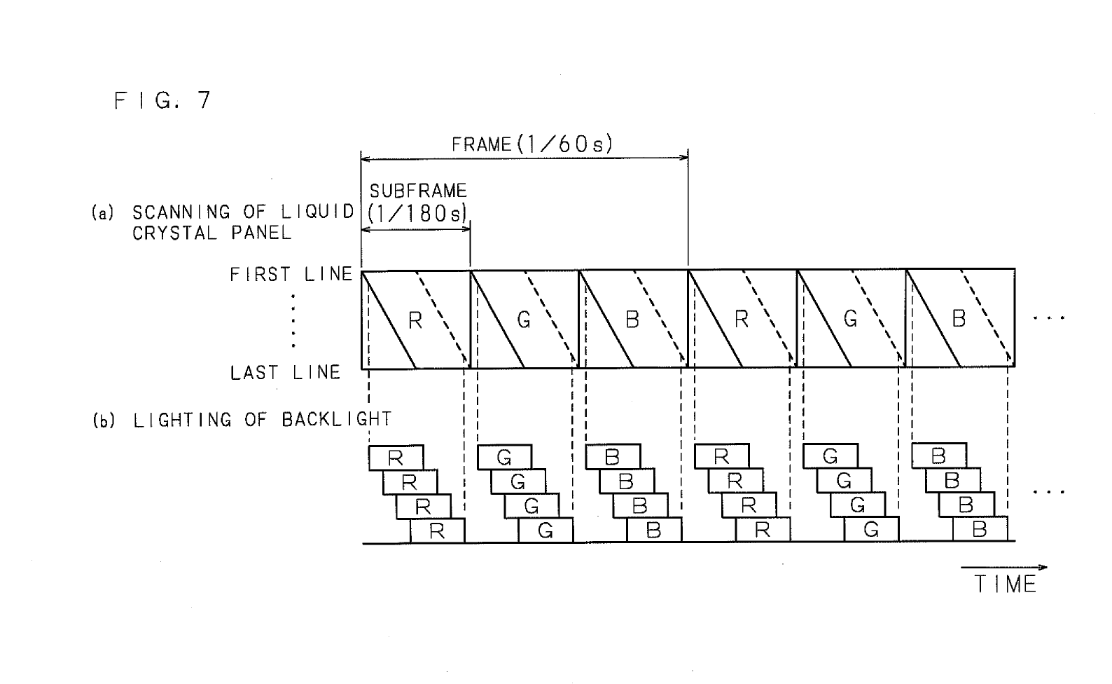

The liquid crystal panel 21 thus produced and the backlight 22 having the LED array 7 as a light source are overlaid, the LED array 7 consisting of 12 LEDs each having a LED element as one chip that emits red (R), green (G), and blue (B) colors. Field-sequential color display is then performed in accordance with a drive sequence such as the one shown in FIG. 7.

With 60 Hz of frame frequency, one frame (period: 1/60 s) is divided into 3 subframes (period: 1/180 s). As shown in FIG. 7(a), for example, two writing scans (primary data-writing scanning and secondary data-writing scanning) of red image data are conducted in the first subframe of one frame. Two writing scans (primary data-writing scanning and secondary data-writing scanning) of green image data are then conducted in the next second subframe. Two writing scans (primary data-writing scanning and secondary data-writing scanning) of blue image data are conducted in the last third subframe.

In each subframe, the time required for each data-writing scanning is set 50% ( 1/360 s) of the subframe ( 1/180 s). In each subframe, a voltage with polarity capable of obtaining a bright display according to the display data is applied to the liquid crystal of each pixel during the first (first half) primary data-writing scanning. During the second (second half) secondary data-writing scanning, based on the same display data as that of the primary data-writing scanning, a voltage having different polarity but the same magnitude as that of the primary data-writing scanning is applied to the liquid crystal of each pixel. As a result, during the secondary data-writing scanning, the dark display substantially able to be considered a black image, compared to during the primary data-writing scanning, is obtained.

Meanwhile, lighting of red, green, and blue colors of the backlight 22 is controlled as shown in FIG. 7(b). In each subframe, between the mid-point of the primary data-writing scanning and the mid-point of the secondary data-writing scanning, the backlight 22 is lit for each of the lighting regions 221, 222, 223, and 224 of which the 12 LEDs of the backlight 22 are divided into four, three pieces each. Therefore, the lighting time of the backlight 22 in each subframe is 50% ( 1/360 s) of the subframe ( 1/180 s).

Consequently, high resolution, high-speed response, and high color purity display are realized. The screen brightness in the display area is in the range of about 160-180 cd/m². At this point, the power consumption of the backlight 22 is 0.55 W. As a result, high luminance display and reduction in power consumption are realized.

### FIRST COMPARATIVE EXAMPLE

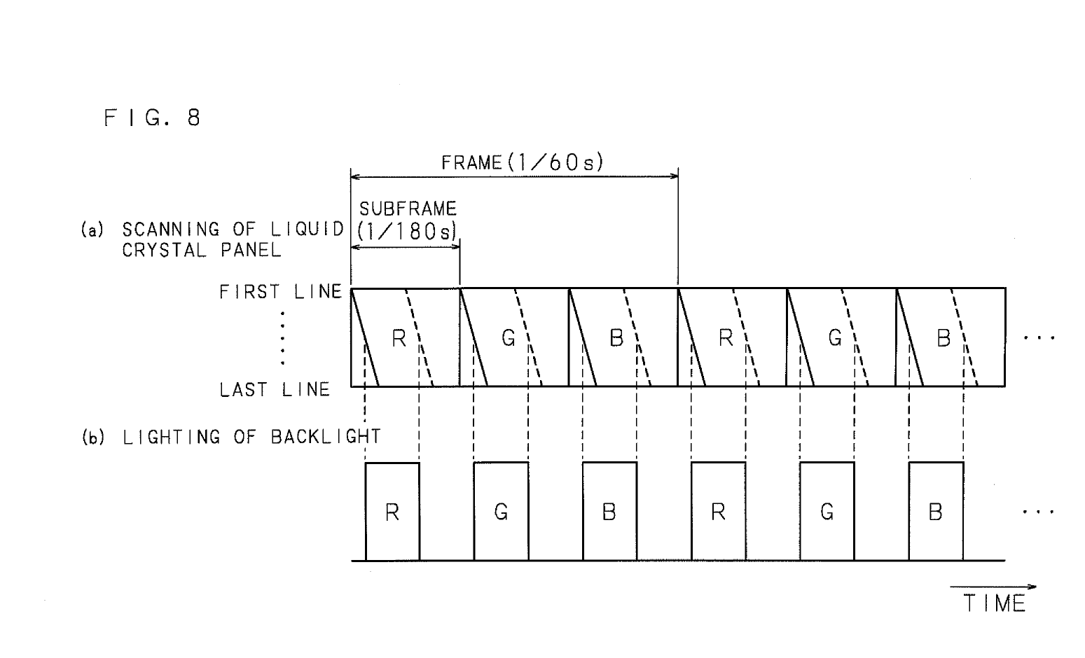

A liquid crystal panel produced as in the first embodiment and a backlight as in the first embodiment are overlaid, and in accordance with the drive sequence such as the one in FIG. 8, the field-sequential color display is performed.

The polarity and the magnitude of the voltage in two data-writing scanning for each subframe shown in FIG. 8(a) are the same as those in the first embodiment (see FIG. 7(a)). However, in each subframe, the time required for the primary data-writing scanning and the secondary data-writing scanning is 25% ( 1/720 s) of the subframe ( 1/180 s), and the time between adjacent two data-writing scanning is also 25% ( 1/720 s) of the subframe ( 1/180 s).

Meanwhile, lighting of the red, green, and blue colors of the backlight is controlled as shown in FIG. 8(b). In each subframe, the backlight is lit between the mid-point of the primary data-writing scanning and the mid-point of the secondary data-writing scanning. However, the backlight is not divided into a plurality of lighting regions as in the first embodiment. Therefore, the lighting time of the backlight in each subframe is 50% ( 1/360 s) of the subframe ( 1/180 s).

Consequently, high resolution, high-speed response, and high color purity display are realized as in the first embodiment. The screen brightness in the display area is in the range of about 135-180 cd/m², and the brightness gradient is greater than that of the first embodiment. In addition, a shorter scanning time than in the first embodiment is required. The power consumption of the backlight is 0.55 W.

### SECOND EMBODIMENT

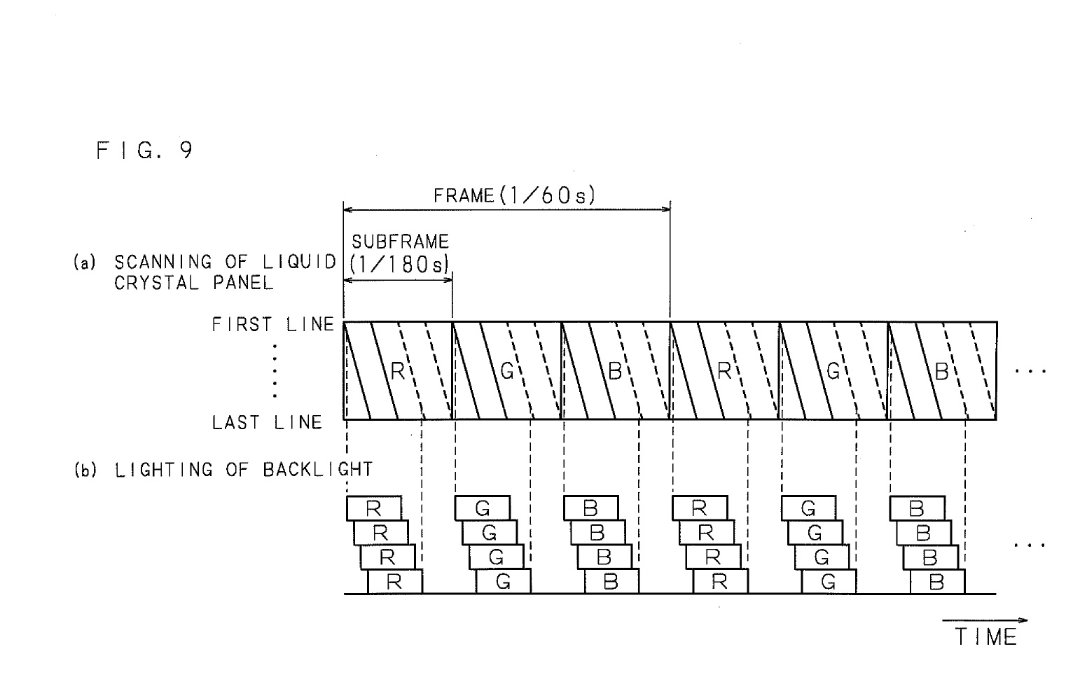

The liquid crystal panel 21 produced as in the first embodiment and the backlight 22 as in the first embodiment are overlaid. The field-sequential color display is performed in accordance with the drive sequence such as the one in FIG. 9.

With 60 Hz of frame frequency, one frame (period: 1/60 s) is divided into 3 subframes (period: 1/180 s). As shown in FIG. 9(a), for example, four writing scans of red image data are conducted in the first subframe within one frame. Four writing scans of green image data are then conducted in the next second subframe. Four writing scans of blue image data are conducted in the last third subframe. In each subframe, the time required for each data-writing scanning is 25% ( 1/720 s) of the subframe ( 1/180 s), and the end timing of previous data-writing scanning and the start timing of subsequent data-writing scanning correspond.

During four data-writing scanning in each subframe, the voltage applied to the liquid crystal of each pixel during two first-half data-writing scans (primary data-writing scanning) and the voltage applied to the liquid crystal of each pixel during two second-half data-writing scans (secondary data-writing scanning) are opposite in polarity and the same in magnitude. As a result, during the two second-half data-writing scans, the dark display substantially able to be considered a black image, compared to during the two first-half data-writing scans, is obtained.

Meanwhile, lighting of red, green, and blue colors of the backlight 22 is controlled as shown in FIG. 9(b). In each subframe, between the mid-point of the first data-writing scan (first data-writing scanning) of the two first-half data-writing scans (primary data-writing scanning) and the mid-point of the first data-writing scan (third data-writing scanning) of the two second-half data-writing scans (secondary data-writing scanning), the backlight 22 is lit for each of the lighting regions 221, 222, 223, and 224 of which the 12 LEDs of the backlight 22 are divided into four, three pieces each. Therefore, the lighting time of the backlight 22 in each subframe is 50% ( 1/360 s) of the subframe ( 1/180 s).

Consequently, high resolution, high-speed response, and high color purity display are realized. The screen brightness in the display area increased compared to the first embodiment to about 190-215 cd/m², as a result of improvement in the transmittance by increasing the number of times of the data-writing scanning. At this point, the power consumption of the backlight 22 is 0.55 W. Therefore, high luminance display and reduction in power consumption are realized.

### SECOND COMPARATIVE EXAMPLE

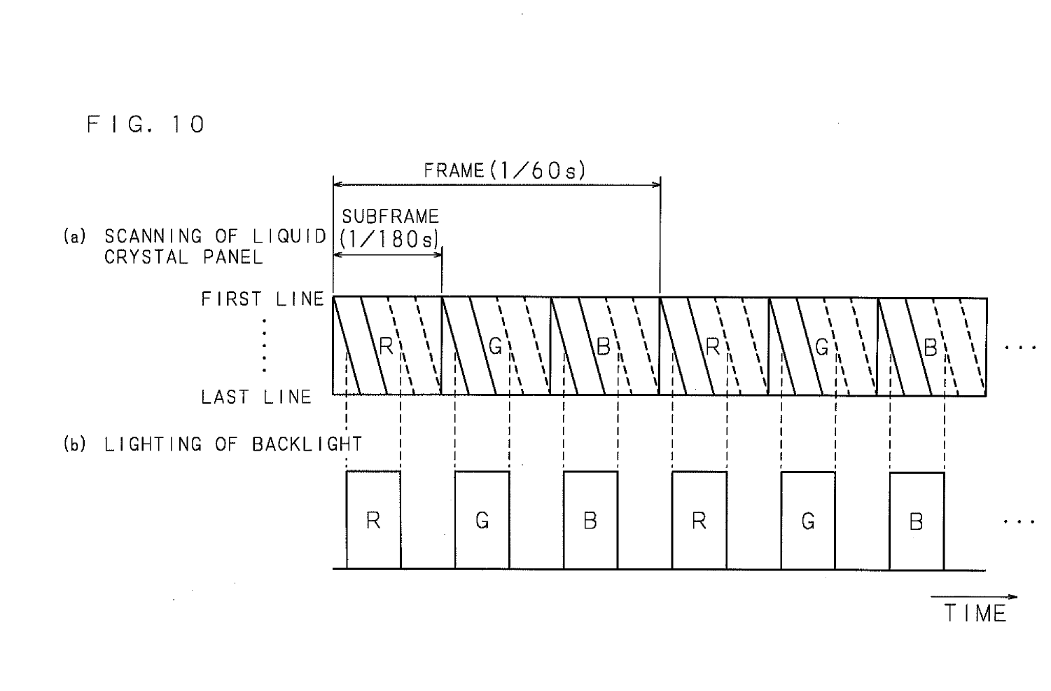

A liquid crystal panel produced as in the first embodiment and a backlight as in the first embodiment are overlaid, and in accordance with the drive sequence such as the one in FIG. 10, the field-sequential color display is performed.

Four data-writing scans in each subframe shown in FIG. 10(a) are exactly the same as those in the second embodiment (see FIG. 9(a)).

Meanwhile, lighting of the red, green, and blue colors of the backlight is controlled as shown in FIG. 10(b). In each subframe, the backlight is lit between the mid-point of the first data-writing scan (first data-writing scanning) of the two first-half data-writing scans (primary data-writing scanning) and the mid-point of the first data-writing scan (third data-writing scanning) of the two second-half data-writing scans (secondary data-writing scanning). However, the backlight is not divided into a plurality of lighting regions as in the second embodiment. Therefore, the lighting time of the backlight in each subframe is 50% ( 1/360 s) of the subframe ( 1/180 s) as in the second embodiment.

Consequently, high resolution, high-speed response, and high color purity display are realized as in the second embodiment. The screen brightness in the display area is in the range of about 160-215 cd/m², and the brightness gradient is greater than that of the second embodiment. The power consumption of the backlight is 0.55 W.

### THIRD EMBODIMENT

Between the alignment films 11 and 12 of the empty panel manufactured by the same process as in the first embodiment, a mono-stable ferroelectric liquid crystal material (for example, R2301 of Clariant Japan) that exhibits half-V-shaped electro-optical response characteristics is enclosed to form the liquid crystal layer 13. The size of the spontaneous polarization of the enclosed ferroelectric liquid crystal material is 6 nC/cm². A uniform liquid crystal alignment is realized by enclosing the liquid crystal material into the panel and then applying a 10V voltage across the transition point from the cholesteric phase to the chiral smectic C phase. The manufactured panel is interposed between two polarization films 1 and 5 in the crossed Nicol arrangement to produce the liquid crystal panel 21, and when the voltage is not applied, it becomes a dark state.

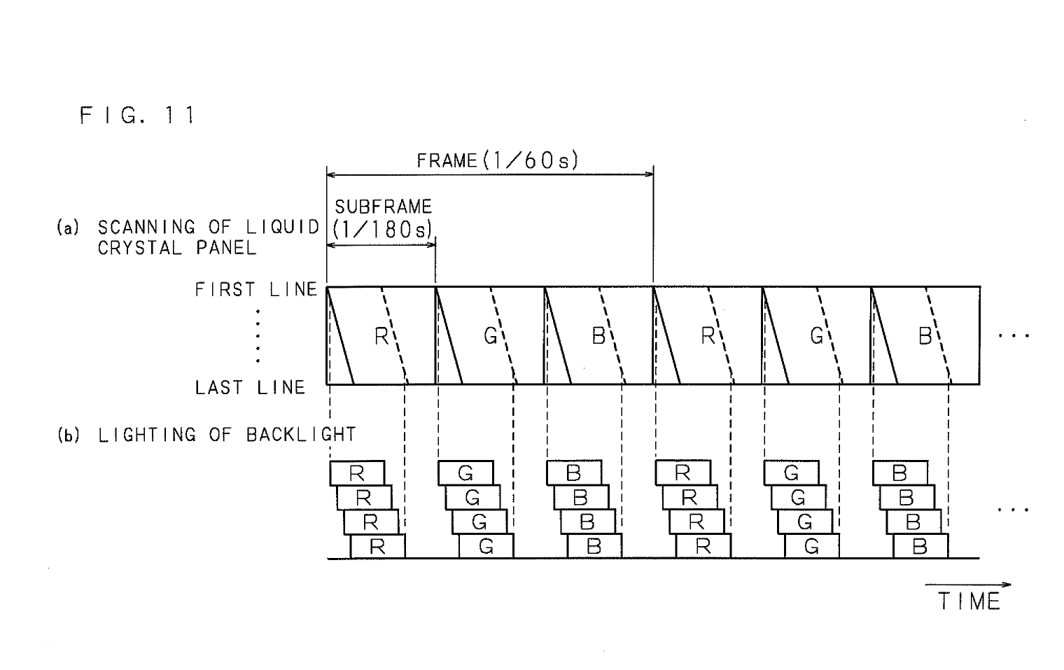

The liquid crystal panel 21 thus produced and the backlight 22 as in the first embodiment are overlaid, and in accordance with the drive sequence in FIG. 11, the field-sequential color display is performed.

With 60 Hz of frame frequency, one frame (period: 1/60 s) is divided into 3 subframes (period: 1/180 s). As shown in FIG. 11(a), for example, two writing scans (primary data-writing scanning and secondary data-writing scanning) of red image data are conducted in the first subframe within one frame. Two writing scans (primary data-writing scanning and secondary data-writing scanning) of green image data are then conducted in the next second subframe. Two writing scans (primary data-writing scanning and secondary data-writing scanning) of blue image data are conducted in the last third subframe.

In each subframe, the time required for the primary data-writing scanning and the secondary data-writing scanning is 25% ( 1/720 s) of the subframe ( 1/180 s), and the time between two adjacent data-writing scanning is also 25% ( 1/720 s) of the subframe ( 1/180 s). In each subframe, a voltage with polarity capable of obtaining a bright display according to the display data is applied to the liquid crystal of each pixel during the first (first half) primary data-writing scanning. During the second (second half secondary data-writing scanning, based on the same display data as in the primary data-writing scanning, a voltage having different polarity but the same magnitude as that of the primary data-writing scanning is applied to the liquid crystal of each pixel. As a result, during the secondary data-writing scanning, the dark display substantially able to be considered a black image, compared to during the primary data-writing scanning, is obtained.

Meanwhile, lighting of red, green, and blue colors of the backlight 22 is controlled as shown in FIG. 11(b). In each subframe, between the mid-point of the primary data-writing scanning and the mid-point of the secondary data-writing scanning, the backlight 22 is lit for each of the lighting regions 221, 222, 223, and 224 of which the 12 LEDs of the backlight 22 are divided into four, three pieces each. Therefore, the lighting time of the backlight 22 in each subframe is 50% ( 1/360 s) of the subframe ( 1/180 s).

Consequently, high resolution, high-speed response, and high color purity display are realized. The screen brightness in the display area is in the range of about 185-200 cd/m². At this point, the power consumption of the backlight 22 is 0.55 W. As a result, high luminance display and reduction in power consumption are realized. The ratio of the brightness gradient can be reduced compared to the first embodiment.

It should be appreciated that although the time required for one data-writing scanning accounts for 50% or 25% of each subframe in the embodiments above, further improvement in light use efficiency and further control of luminance unevenness can be achieved by reducing the ratio and lengthening the time between two adjacent data-writing scanning.

It should also be appreciated that although the division number of the backlight 22 to the plurality of lighting regions is four in the embodiments above, the division number is not limited to this, and by increasing the division number, further improvement in light use efficiency and further control of luminance unevenness can be achieved.

It should be understood that although cases of using liquid crystal materials having half-V-shaped electro-optical response characteristics are described in the examples above, the present invention can be similarly applied to a case of using a liquid crystal material having V-shaped electro-optical response characteristics. Even in such a case, in each subframe, although the voltage applied to the liquid crystal of each pixel during the first half of the primary data-writing scanning and the voltage applied to the liquid crystal of each pixel during the second half of the secondary data-writing scanning are opposite in polarity and substantially the same in magnitude, since a liquid crystal material having V-shaped electro-optical response characteristics is used, the display of substantially the same brightness compared to during the first half of the primary data-writing scanning can be obtained during the second half of the secondary data-writing scanning.

Although a filed-sequential liquid crystal display device is described as an example in the embodiments above, similar effects can be obtained with a color-filter liquid crystal display device provided with color filters. Because, the present invention can be similarly implemented by applying the drive sequence of the subframes in the field-sequential method to the frames in the color-filter method.

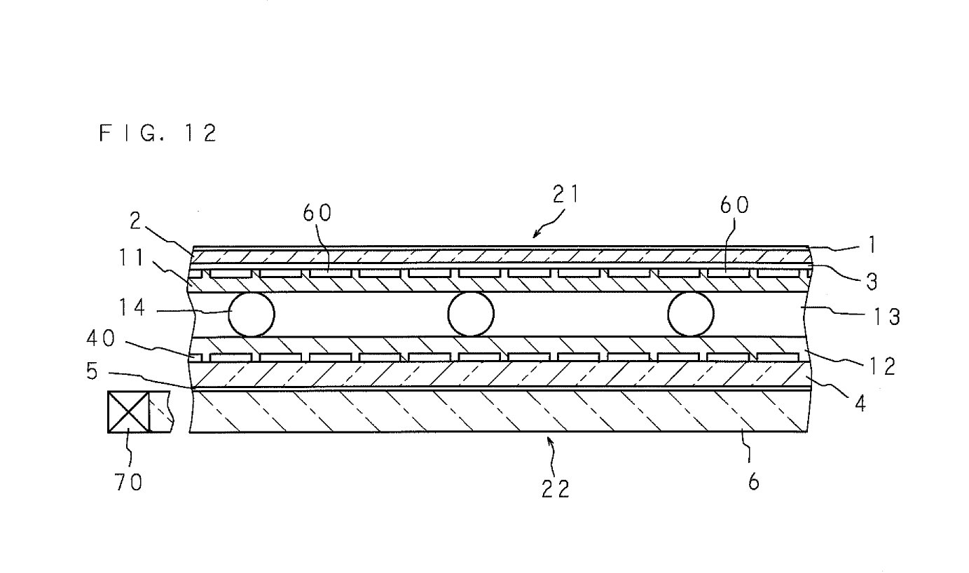

FIG. 12 is a schematic cross-sectional view of a liquid crystal panel and a backlight in a color-filter liquid crystal display device. In FIG. 12, like reference numerals refer to like parts in FIG. 4 and will not be described. The common electrode 3 is provided with color filters 60, 60 . . . of three primary colors (R, G, and B). The backlight 22 is composed of a white light source 70, including a plurality of white light source elements that emit the white light, and the light guide and light diffusion plate 6. In such a color-filter liquid crystal display device, the color display is performed by selectively penetrating the white light from the white light source 70 with a plurality of color filters 60. The backlight 22 (white light source 70) is divided into a plurality of lighting regions.

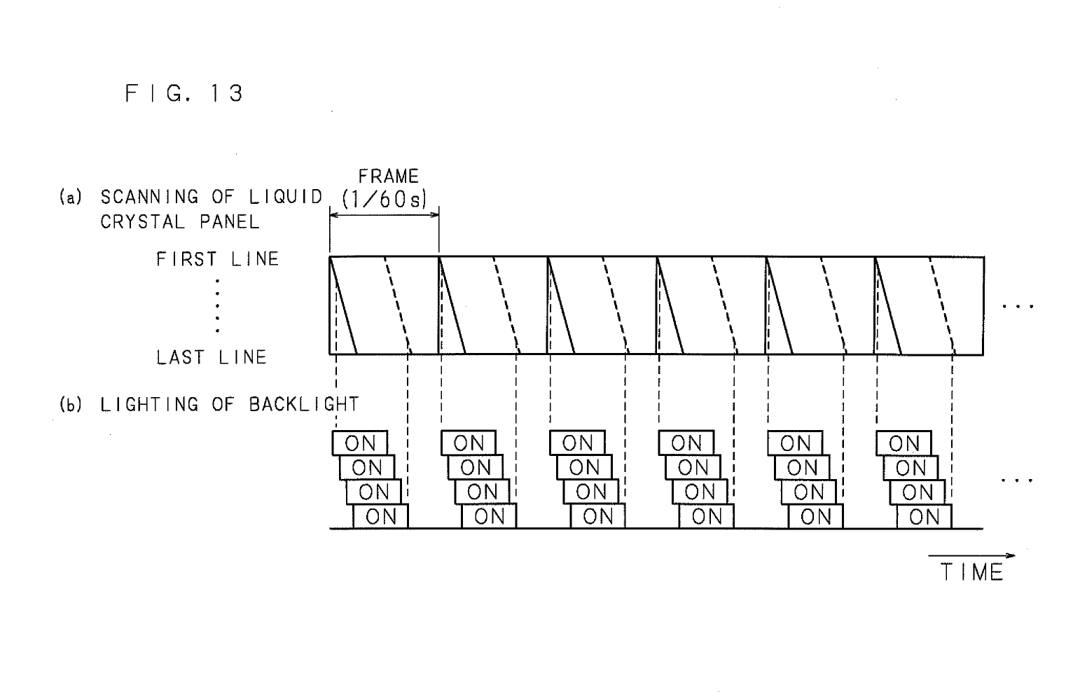

By performing the color display according to the drive sequence in FIG. 13 (lighting the backlight 22 between the mid-point of the primary data-writing scanning and the mid-point of the secondary data-writing scanning for each of the lighting regions of which the backlight 22 is divided into four in each frame), successful outcomes of improvement in light use efficiency and reduction in power consumption can be accomplished even in the color-filter liquid crystal display device as in the field-sequential liquid crystal display device. In addition, the brightness gradient can be reduced, and the scanning time can be lengthened.

In the embodiments above, although cases of using ferroelectric liquid crystal materials having spontaneous polarization are described, if the drive display method is similar, similar effects can be obtained when using other liquid crystal materials having spontaneous polarization such as an antiferroelectric liquid crystal material or when using nematic liquid crystal materials not having spontaneous polarization. The present invention is not limited to the transmissive liquid crystal display device, but can be applied to a reflective liquid crystal display device and a front/rear projector.

1-9. (canceled)

10. A liquid crystal display device, comprising:
a liquid crystal panel in which a liquid crystal material is enclosed;
a light source that is divided into a plurality of lighting regions and emits a light entering into the liquid crystal panel;
a synchronizing unit that synchronizes lighting control of the light source and multiple data-writing scanning to the liquid crystal panel for each predetermined period; and
a control unit that lights the light source between corresponding timings of a first scanning of at least one primary data-writing scanning within the predetermined period corresponding to each of the lighting regions and the first scanning of at least one secondary data-writing scanning for obtaining darker display or display of substantially identical brightness as that of the primary data-writing scanning.

11. The liquid crystal display device of claim 10, wherein the corresponding timings are substantially mid-points of the first scanning, respectively.

12. The liquid crystal display device of claim 10, wherein, in conjunction with each of a plurality of pixels, a switching element that controls a voltage applied to the liquid crystal material is provided.

13. The liquid crystal display device of claim 10, wherein the liquid crystal material includes spontaneous polarization.

14. The liquid crystal display device of claim 10, wherein a voltage applied to the liquid crystal material in the primary data-writing scanning and a voltage applied to the liquid crystal material in the secondary data-writing scanning are substantially identical in magnitude and different in polarity.

15. The liquid crystal display device of claim 10, wherein the secondary data-writing scanning is conducted after the primary data-writing scanning.

16. The liquid crystal display device of claim 10, wherein a color display is performed by a field-sequential method.

17. The liquid crystal display device of claim 10, wherein a color display is performed by a color-filter method.

18. The liquid crystal display device of claim 10, wherein the light source is a light emitting diode.
